(19) United States
(12) Patent Application Publication
(10) Pub. No.: US 2008/0177585 A1
(43) Pub. Date: Jul. 24, 2008

(54) Method Apparatus and Computer Program For Managing Purchases

(76) Inventors: Henrik Skinstad, Stocksund (SE); David Logg, Lidingo (SE); Robert Skinstad, Vallentuna (SE)

Correspondence Address: ALBIHNS STOCKHOLM AB, BOX 5581, LINNEGATAN 2, SE-114 85 STOCKHOLM; SWEDENn, STOCKHOLM, omitted

(21) Appl. No.: 10/596,315

(22) PCT Filed: Dec. 13, 2004
(86) PCT No.: PCT/SE04/01861

§ 371 Date: Jun. 9, 2006

(30) Foreign Application Priority Data
Dec. 12, 2003 (SE) 0303367-7

(51) Int. Cl. G06Q 10/00

(52) U.S. Cl. 705/7

(57) ABSTRACT

The present invention relates to an apparatus and a method for managing and auditing purchases in progress which are made by a number of individuals belonging to a liable organisation, such as employees making purchases in parallel on behalf of a company. The invention comprises a managing server, including a storage means and issuing means, a client terminal connected to a network for providing information to the storage means about purchasing rules for individuals purchasing on behalf of their organisation. The issuing means is adapted to generate a unique number, the number being issued and distributed to a purchasing individual, in dependence on the purchasing rules and a first communication terminal operated by a provider is adapted to, in response to a purchase, provide information to the managing server relating to a purchase in progress. Moreover, the invention is characterised in that the server is adapted examine whether information provided is in accordance with the purchasing rules, as a result of which a notification is sent to the first communication terminal so as to validate the purchase.

### FIELD OF THE INVENTION

The present invention relates to an apparatus, method for managing and auditing purchases in progress which are made by a number of individuals belonging to a liable organisation. Employees making purchases in parallel on behalf of a company is a conceivable example in practice. More in detail, the present invention relates to means for administrating purchase of a product or service using a number or a valuable document. The present invention further relates to a computer program for carrying out the method for managing and auditing electronic transactions.

### BACKGROUND OF THE INVENTION

Anybody who has been involved in industrial, administrative or other professional activities has noticed the vast amount of paper work required. Most companies have a large number of employees for carrying out administrative tasks only, and it would be beneficial to be able to improve efficiency and accuracy as well as reduce the number of administrative staff and associated costs.

In particular in large organisations, it is difficult to get an overview of pending transactions, since there it takes time from the moment when a purchase, irrespective of the size of it, is agreed on and the moment in time for the fiscal transaction. For management, or for the administration and cash flow management, there is a desire to monitor transactions much closer than today. There is thus a need to facilitate a semi or fully automated administration of for example invoices and other valuable documents.

The US patent application 2003/0079220, published on 24 Apr. 2003, discloses a method for restricting the distribution of negotiable discount coupons to individual consumers via a distributed processing network. Each of the subscribing consumers is allowed to download and print from a server system negotiable discount coupons, each of which reflects and authorised offer, and wherein the consumer is restricted from printing coupons beyond certain imposed restrictions.

However, the method disclosed in US patent application 2003/0079220 does not simplify or automate administration of a large number of transaction being made for which an organisation is liable. Moreover, the method does not assist management in monitoring or obtaining an overview of pending transactions within the organisation.

### SUMMARY OF THE INVENTION

An object of the present invention relates to the problem of achieving a cost effective apparatus and method managing and auditing electronic transactions in that valuable documents are administrated.

This is achieved by an apparatus for managing and auditing purchases in progress which are made by a number of individuals belonging to a liable organisation, such as employees making purchases in parallel on behalf of a company, the apparatus comprising
a managing server connected to an global interconnected network, such as the Internet, the server including a storage means and issuing means,
a client terminal connected to the network for providing information to the storage means of the server about purchasing rules for individuals purchasing on behalf of their organisation,
the issuing means adapted to generate a unique number, the number being issued and distributed to a purchasing individual, in dependence on the purchasing rules,
a first communication terminal operated by a provider is adapted to, in response to a purchase, provide information to the managing server relating to a purchase in progress,
   characterised in that
the server is adapted examine whether information provided is in accordance with the purchasing rules, as a result of which a notification indicating the validity of the purchase is sent to the first communication terminal.

The present invention is advantageous in many ways. One of the major advantages is that a provider of a product or service will be certain that an individual has the required authorisation to make a purchase. Another advantage is that the purchasing organisation, i.e. in most cases the employer, always will be informed about the identity of the individual, i.e. the employee, who has made or is about to make a purchase. In comparison with for example corporate credit cards, the purchasing individual does not have to be employed in a legal sense by the purchasing organisation in order to benefit from using the present invention and its principles. Also consultants or others acting on behalf of a purchasing organisation are thus encompassed leading to mutually increased trust in business between purchasing individuals and providers. Other benefits of the invention will be apparent from the following description and from the dependent claims.

In accordance with one aspect of the present invention the issuing means is adapted to generate a unique number. This the number is issued and subsequently distributed to a second communication terminal operated by a purchasing individual. The unique number, i.e. a reference number, is referring to the purchasing rules set up by the purchasing organisation for itself as well as for its individuals. Distribution of the unique number to the second communication terminal has the advantage that the generated number can be provided directly to any bearing means of the purchasing individual without having to be printed on a coupon or involve valuable documents of various kinds.

The second communication terminal which is operated by a purchasing individual could be adapted, in response to a purchase, to provide information to the managing server relating to a purchase in progress. Such a solution would be highly beneficial in that a supplier of goods or a provider of services would not have to use his own cash register or the like for communicating with the managing server, but instead the second communication terminal of the purchasing individual could be used for validating the purchase via the server. This would improve the flexibility of the present invention even further. However, this alternative solution does not prevent the provider from obtaining an advanced validity statement before a purchase is made.

Another important aspect of the invention is the client terminal is adapted to be operated by the purchasing organisation. This is a necessary feature for information management reasons, since is gives the purchasing organisation an opportunity to keep authorisations and limitations for individuals secret and confidential within in the purchasing organisation. It is quite understandable and obvious that most companies tend to be reluctant to having to fill out forms with sensitive information and send them to a third party handling the transactions. This is avoided by means of the present invention.

For improved cash management, and up to date information about pending expenses for a company, the managing server is adapted to send a notification also to the purchasing organisation. This is done immediately as a result of the examination and in accordance with one embodiment of the invention, it is to be notified in addition to the notification to the first and/or second communication terminal. The present invention is a way for the provider to acquire a right to invoice on condition that the unique number and the transaction amount is correct, which has already been validated and accepted by the purchasing individual and his organisation. Moreover, since correct transaction amount is a condition for validation, the risk for the purchasing organisation to be over-billed is avoided. In order to send invoices in a suitable and desirable format, taking routines, security levels of transport and content into account, this information could be retrieved from the managing server upon request by any authorised invoicing service. The authorisation is evident in case the correct unique number is used when requesting the managing server for specific invoicing information. The advantage achieved is making electronic invoicing possible for all transactions, which has not yet been possible in practice.

The unique the number includes a logical part and a random part. The logical part includes structural data, such as organisation, department, name of purchasing individual and serial number of issued unique numbers for validation. Standard formats such as EAN or DUNS are feasible for use. The random part is a number for increased security, preferably any four digit number for sufficient system security.

According to an alternative embodiment of the invention, the unique number is distributed to the second communication terminal either via a smart card or by printing the unique number on a purchasing coupon, preferably in the form of a bar code. This has the advantage of requiring a minimum of electronic terminals and thereby simplifies the means for distribution. Reading a bar code instead of typing in a number further simplifies and increases the efficiency and usability of the present invention.

Preferably, information provided from the first and/or second communication terminal to the managing server, which relates to a specific purchase includes the unique number and the cost of the purchase. This has the advantage that an amount can be reserved immediately, either from a predetermined budget or from a corresponding debiting account so as to avoid double charging or overdrawing an account. Above all, this provides for considerable improvements in cash management.

In addition to the above benefits, the invention makes it possible to reduce administration in another way. For valid purchase, the first and/or second communication terminal connects to an electronic invoicing service, which is adapted to execute invoicing in accordance with the specific requirements for payment of the purchasing organisation. This makes it possible to use electronic invoicing for all purchases, thereby significantly reducing administrative costs in any organisation.

Moreover, this is achieved by a method for managing and auditing purchases in progress which are made by a number of individuals belonging to a liable organisation, such as employees making purchases in parallel on behalf of a company, the method comprising the steps of:
connecting a managing server to an global interconnected network, such as the Internet, the server including a storage means and issuing means,
providing information to the storage means of the server about purchasing rules for individuals purchasing on behalf of their organisation which information is provided by a client terminal connected to the network,
generating a unique number by the issuing means, the number being issued and distributed to a purchasing individual in dependence on the purchasing rules,
in response to a purchase, providing information to the managing server relating to a purchase in progress, by means of a first communication terminal operated by a provider,
   characterised in that
examining by the server whether information provided is in accordance with the purchasing rules, as a result of which a notification is sent to the first communication terminal so as to validate the purchase.

By the method for managing and auditing purchases, an automation of other known manual processes is achieved, which is a great improvement and has potential for rationalisation of the important, demanding and technically broad field of electronic transactions. Furthermore and not less important is that organisations, particularly large ones, can achieve improved control and overview of available funds using the apparatus and method according to the invention.

### BRIEF DESCRIPTION OF THE DRAWINGS

The above and further features, advantages and benefits of the present invention will be apparent upon consideration of the following detailed description. The detailed description is to be taken in conjunction with the accompanying drawings, in which the same reference characters and figures refer to the same components or method steps throughout, and in which:

FIG. 1 illustrates schematically a system including an apparatus for managing and auditing valuable information according to one embodiment of the invention.

FIG. 2 schematically shows a part of FIG. 1 with an additional feature according to one embodiment of the present invention.

FIG. 3 schematically shows a valuable document according to an embodiment of the present invention.

FIG. 4 illustrates schematically software modules according to an embodiment of the present invention.

FIG. 5 illustrates schematically a method for managing valuable documents according to one embodiment of the present invention.

FIG. 6 illustrates schematically in greater detail a method for managing valuable documents according to an embodiment of the present invention.

FIG. 7 illustrates an electronic device according to an embodiment of the present invention.

### DETAILED DESCRIPTION OF THE EMBODIMENTS

The following description is of the best mode presently contemplated for practising the invention. The description is not to be taken in a limiting sense, but is made merely for the purpose of describing the general principles of the invention. The scope of the invention should be ascertained with reference to the issued claims.

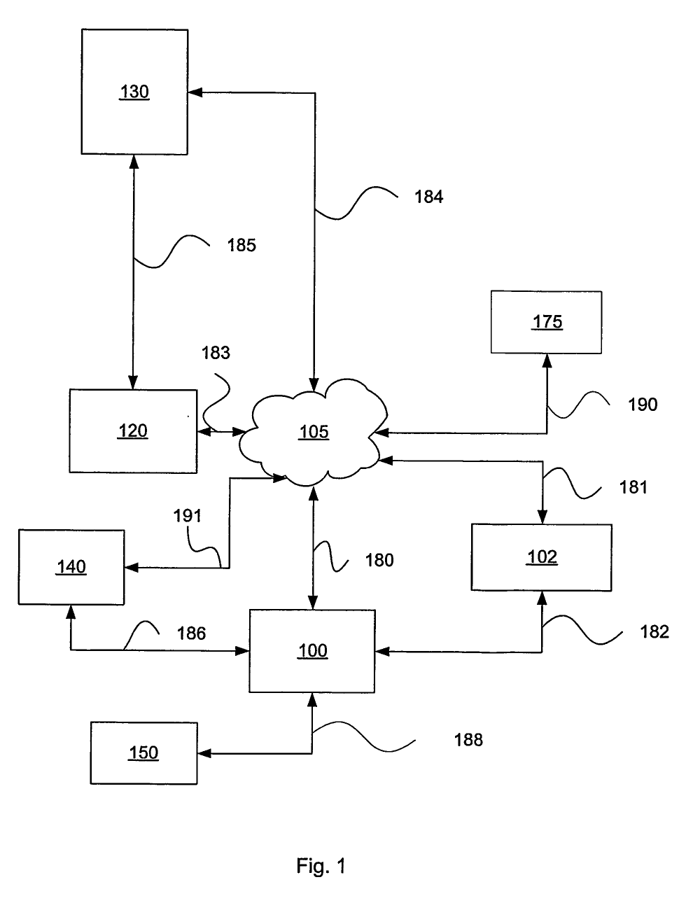

With reference to FIG. 1, a system including an apparatus for managing valuable documents in disclosed. In particular it relates to a system for managing invoices. A server 100 is adapted for communication with an issuing means 150, such as for example a printing unit via a link 186. However, the generated unique number could as well be provided directly to the purchasing individual via a communication terminal, such as a mobile phone. The server 100 is adapted for communication with a network 105 via a communication link 180. The network is a global interconnecting network, such as the Internet. A communication terminal 102 is adapted for communication with the server 100 via communication link 182. The communication terminal 102 is managed by an administrator of the server 100. The communication terminal 102 may also be adapted for communication with the server via the network 105. The server 100 is adapted for communication with a database 140 via a communication link 186. The database 140 is adapted for communication with the network 105 via a communication link 191. Communication terminals referred to herein may be a PC, a cellular phone, a handheld device, a PDA or other.

A communication terminal 120 is adapted for communication with the network 105 via a communication link 183. The communication terminal 120 is managed by a vendor. The communication terminal 120 is adapted for communication with a communication terminal 130. The communication terminal 130 may also be a plurality of communication terminals connected together via an intranet. The communication terminal is managed by an organisation. The communication terminal 130 is adapted for communication with the network 105 via a communication link 184. An invoice service 175, such as an electronic invoicing service or other web-based invoice service, is adapted for communication with the network 105 via a communication link 190. The invoice service 175 also includes a communication terminal.

A representative of the purchasing organisation provides information about the organisation and specific demands relating to the invoicing or administration and control of the provided information to the server. This is accomplished by means of software installed on at least one clients, i.e. communication terminals 130, administered by the purchasing organisation, not the least for security reasons.

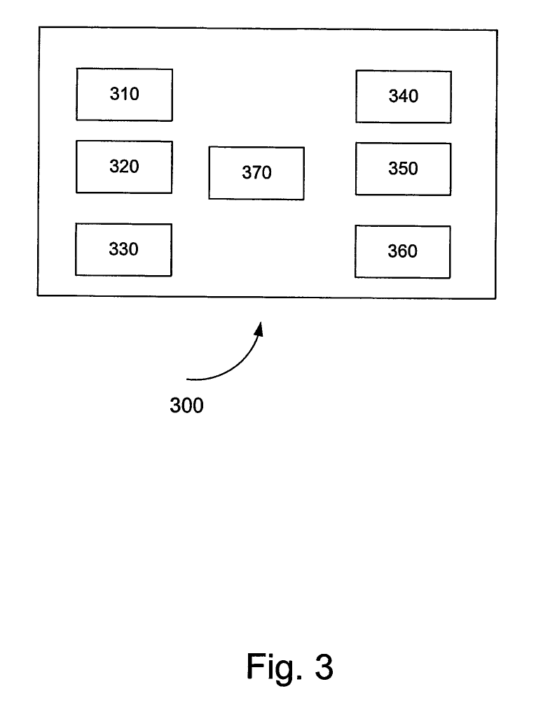

The server 100 is adapted to receive and process the provided information. As a result of the processing valuable documents, such as coupons can be generated and printed by means of the printing device 150. The processed information is stored in the database 140. The created valuable documents are distributed to the organisation and there provided to respective user. Each user or group of users has unique valuable documents, which each has a unique number associated to it. For example may reference number provided on a valuable document be created in dependence of a certain user or a group of users. A valuable document is described in further detail with reference to FIG. 3.

A user then is performing a purchase in a specific store, or the like. The user may fill out certain information fields provided on the valuable document and further identify himself to a vendor. The vendor manages the communication terminal 120. Instructions how to successfully accomplish the buy is provided on for example the valuable document.

The unique number or reference number could be created in accordance with the following principle, *1001*-1001-34-6476 specific organisation number, which is a serial number provided to any company or organisation. 1001-*1001*-34-6476 which is a specific four digit number for a certain purchasing employee. This number may be a real employee number or a number created for this purpose. 1001-1001-*34*-6476 which is the serial number of a specific coupon or a batch of coupons provided to the purchasing individual. 1001-1001-34-*6476*, which illustrates a generated random number from 0001 to 9999. Naturally, the digits could be any number, however a larger number of digits yields increased fraud security.

The vendor can receive a status report referring to the user's credit rating by connecting to the server 100 by means of the communication terminal 120. A unique reference number provided on the reference carrier, either in electronic form via a communication terminal or possibly as a valuable document in paper form, is used in the validation process performed in the server 100 interacting with the database 140. If the validation turns out well, the purchase is accomplished. The user get access to the product or service in question. The vendor is in a next step connecting to an invoice service provided by either the server 100, the organisation managing the communication terminal 130 or a third party managing the communication terminal 175. The vendor can, by means of the communication terminal 120, receive specific invoicing information or be referred to any international invoicing standard. This information could be received from a tailored invoice interface, such as a web-based interface. The purchasing organisation can hereby get relevant information referring to the purchase in a desired format, which is easy to administrate. Preferably, the administration is performed automatically. A bank service, not shown, is in the end performing an adequate transaction of money corresponding to the purchase.

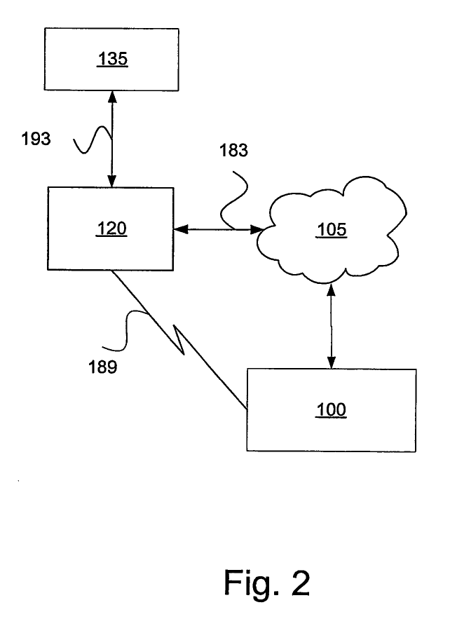

FIG. 2 illustrates an alternative embodiment concerning the validation process of the coupon 300 performed at the vendor at communication terminal 120. A bar code reader 135 is adapted for communication with the communication terminal 120 via a communication link 193. The bar code reader 135 is adapted for communication with the server 100 via a communication link 189. The vendor can by means of the bar code reader 135 fast, accurate and secure read the unique bar code provided on the coupon so as to perform a part of a validation procedure. Information related to the bar code is transmitted to the communication terminal 120 and further sent to the server 100 so as to be processed.

FIG. 3 schematically shows a valuable document 300, such as an invoice coupon. The invoice coupon is stored or printed to any bearer of information, and could even be printed on a piece of paper. Alternatively, the coupon may be composed of plastic or other material. The coupon comprises a number of information fields. The information fields may comprise printed information. The information fields may be blank. A blank information field may be filled out by the user of the coupon. Alternatively, a blank information field may be filled out by the vendor.

A first information field 310 comprises a name of the user. Alternatively, the first information field 310 comprises information related to the user so as to make an identification procedure possible. A second information field 320 comprises a technical address, or the like, where to the vendor is supposed to turn to complete the purchase. In a preferred embodiment, the address is any address, for instance an URL-address, to which the vendor could gain access by using the network 105 in order to receive or provide information for invoicing purposes. A third information field 330 comprises a unique coupon reference number N. This number is unique for the invoice coupon. The number is then issued and stored or printed by the issuing means 150 connected to the server 100. The reference number can be an invoice reference number, and possibly be printed on a coupon. A fourth information field 340 is a blank field in which information about what product or service the buy is concerning, e.g. a PC. In a fifth information field 350 an amount of money is supposed to be provided. The amount of money is corresponding to the value of the desired product or service.

In a sixth information field 360 a signature, possibly an electronic signature, of the purchasing individual to be provided, so as to accomplish the buy. In a seventh information field 370 other information may be provided. According to one embodiment a bar code is provided. The bar code can be read by the bar code reader 135 shown in FIG. 2. Furthermore, on the other side of the coupon, instructions how to handle a selling procedure is given. The purpose of providing the instructions is to facilitate for the vendor. The given instructions may be unique for a certain coupon. In a preferred embodiment the instructions are general.

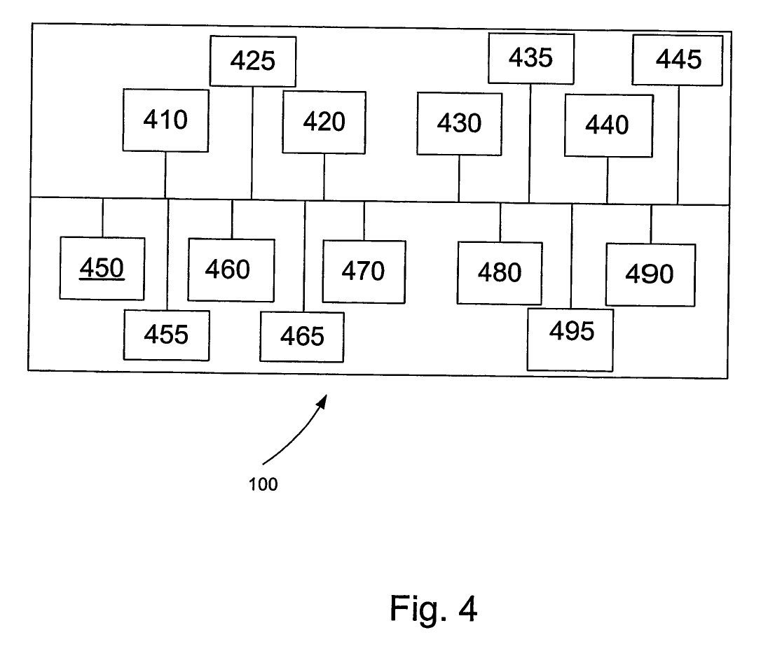

FIG. 4 illustrates examples of software modules stored in a memory in the server 115. The modules can be written in for example Java, C++, HTML or other. A log on module 410 is provided so as to give access of a service provided by the server 100. The identity of a user may be established by this module. A profile managing module 420 is provided. An administration nodule 425 is provided. A communication managing module 430 is provided. A coupon design module 435 is provided. A reference number generating module 440 is provided. A flow design module 445 is provided. An upgrading module 450 is provided. A currency managing module 455 is provided. A invoice module 460 is provided, possibly in the form of a web-based module. A language managing module 465 is also provided. An import and export module 470 is provided. A transaction managing module 495 is provided. A rules and regulations module 490 is provided. The software modules stored in the memory in the server 100 are not limited to the modules described with reference to FIG. 4 but other modules may of course be provided.

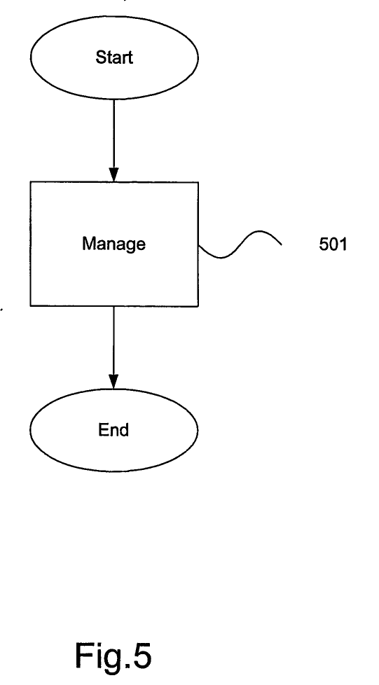

FIG. 5 illustrates a method for administrating electronic documents according to an aspect of the invention. A step s501 comprises a method managing at least one valuable document, the method is comprising the steps of: providing information, creating said valuable document, distributing said valuable document, purchasing a product or a service using said valuable document, validating said purchase in dependence of said valuable document, and invoicing said purchase.

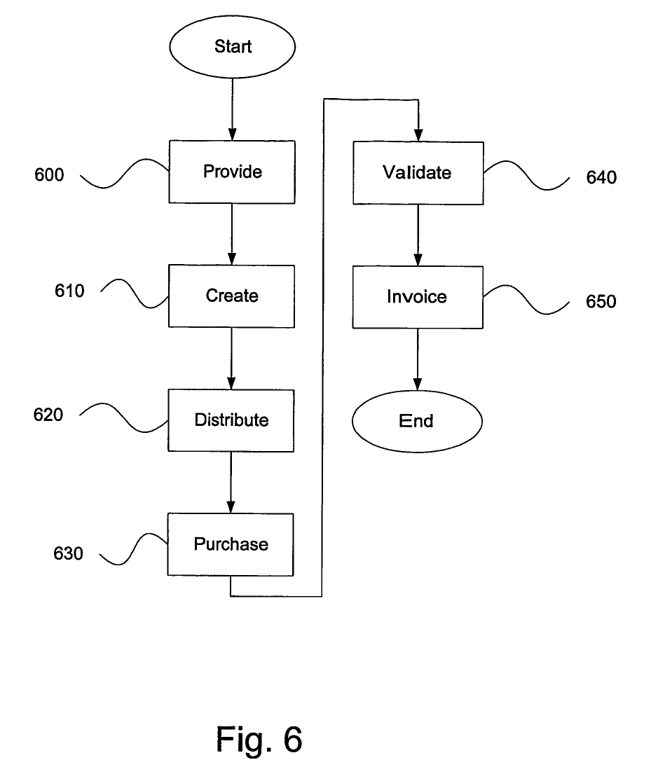

FIG. 6 illustrates a method in further detail according to an aspect of the invention. According to a first method step s600 a representative for the organisation mentioned above provide the server 100 with relevant information by means of the communication terminal 130 so as to initiate a provided service. The information comprises a demand profile for the purchasing organisation and for each of the users who is intended to be using the system. According to a second method step s610 coupons are created in dependence of the information provided to the server 100 according to step s600. According to a next method step s620 the created coupons are distributed to the users of the same, i.e. members of the organization, such as employees of a company. According to a next method step s630 a user is purchasing a product or service of the vendor managing the communication terminal 120. According to a next method step s640 a validation process is performed. According to a next method step s650 an invoicing process is performed.

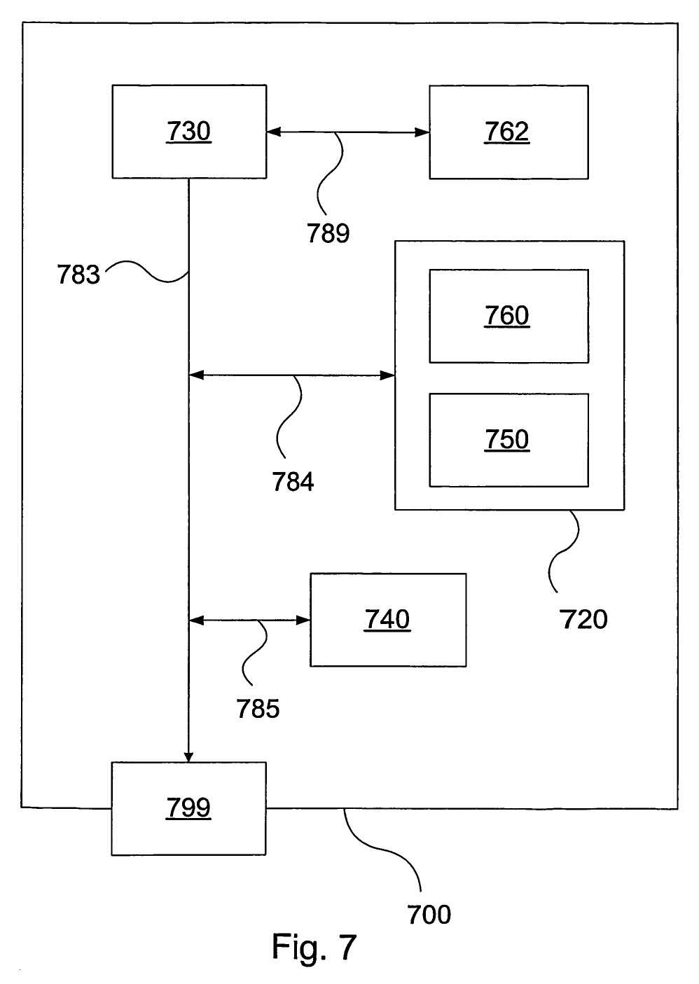

With reference to FIG. 7 there is shown a diagram of one way of embodying an apparatus 700. The above mentioned communication terminal 102, 120, 130 and server 115 may include an apparatus 700. The apparatus 700 comprises a non-volatile memory 720, a data processing device 730 and a read/write memory 740. The memory 720 has a first memory portion 750 wherein a computer program, such as an operating system, is stored for controlling the function of the apparatus 700. Further, the apparatus 700 comprises a bus controller, a serial communication port, I/O-means, an A/D-converter, a time date entry and transmission unit, an event counter and an interrupt controller (not shown).

The data processing device 730 may be embodied by, for example, a microprocessor. The memory 720 also has a second memory portion 760, where software modules with reference to FIG. 4 are stored. In particular this concerns the server 100. In another embodiment the software modules with reference to FIG. 4 are stored on a separate non-volatile recording medium 762. The program may be stored in an executable manner or in a compressed state. When it is described that the data processing device 730 performs a certain function this is to be understood that the data processing device 730 performs a certain part of the program which is stored in the memory 760 or a certain part of the program which is stored in the recording medium 762.

The data processing device 730 may communicate with a data port 799 by means of a data bus 783. The memory 720 is adapted for communication with the data bus 783 via data bus 785. The separate non-volatile recording medium 762 is adapted to communicate with the data processing device 730 via data bus 789. The read/write memory 740 is adapted to communicate with the data bus 783 via a data bus 785. Parts of the methods described with reference to FIGS. 5 and 6, respectively, can be performed by the apparatus 700 by means of the data processing device 730 running the program stored in the memory portion 760. When the apparatus 700 runs the program parts of the method described with reference to FIG. 5 and/or FIG. 6 is executed. When data is received on the data port 799 said input data is temporarily stored in the read/write memory 740. When the received input data have been temporarily stored, the data processing device is set up to perform execution of code in a manner described above.

The foregoing description of the preferred embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated.

1. An apparatus for managing purchases in progress which are made by a num-ber of individuals belonging to a liable organization, such as employees making purchases in parallel on behalf of a company, the apparatus comprising
a managing server (100) connected to an global interconnected network (105), such as the Internet, the server including a storage means (140) and is-suing means (150),
a client terminal (130) connected to the network for providing information to the storage means of the server about purchasing rules for individuals purchasing on behalf of their organization,
the issuing means adapted to generate a unique number, the number being issued and distributed to a purchasing individual, in dependence on the purchasing rules,
a first communication terminal (120) operated by a provider is adapted to, in response to a purchase, provide information to the managing server relating to a purchase in progress, wherein
the server is adapted examine whether information provided is in accordance with the purchasing rules, as a result of which a notification is sent to the first communication terminal so as to validate the purchase.

2. An apparatus for managing purchases according to claim 1, wherein the issuing means is adapted to generate a unique number, the number being issued and distributed to a second communication terminal operated by a purchasing individual, in dependence on the purchasing rules.

3. An apparatus for managing purchases according to claim 1, wherein the second communication terminal operated by a purchasing individual could be adapted, in response to a purchase, provide information to the man-aging server relating to a purchase in progress.

4. An apparatus for managing purchases according to claim 1, wherein the client terminal is operated by the purchasing organization.

5. An apparatus for managing purchases according to claim 1, wherein as a result of the examination, the managing server sends a notification also to the purchasing organization in addition to the notification to the first and/or second communication terminal.

6. An apparatus for managing purchases according to claim 1, wherein the unique the number includes a logical part and a random part, the logical part including at least one of organization, department, individual and serial number of issued numbers, and the random part being any four digit number.

7. An apparatus for managing purchases according to claim 1, wherein the unique number is distributed to the second communication terminal either via a smart card or by printing the unique number on a purchasing coupon, preferably in the form of a bar code.

8. An apparatus for managing purchases according to claim 1, wherein the information provided from the first and/or second communication terminal to the managing server relating to a purchase includes the unique number and the cost of the purchase for reservation of the corresponding the amount on a debiting account.

9. An apparatus for managing purchases according to claim 1, wherein for valid purchase, the first and/or second communication terminal connects to an electronic invoicing service (175), which is adapted to execute invoicing in accordance with the specific requirements for payment of the purchasing organization.

10. An apparatus for managing purchases according to claim 9, wherein the electronic invoicing service is adapted to connect to the managing server for retrieval of specific routines stored thereon for invoicing relating to the purchasing organization.

11. A method for managing purchases in progress which are made by a number of individuals belonging to a liable organization, such as employees making purchases in parallel on behalf of a company, the method comprising the steps of:
connecting a managing server (100) to an global interconnected net-work (105), such as the Internet, the server including a storage means (140) and issuing means (150),
providing information to the storage means of the server about purchasing rules for individuals purchasing on behalf of their organization which information is provided by a client terminal (130) connected to the network,
generating a unique number by the issuing means, the number being is-sued and distributed to a purchasing individual in dependence on the purchasing rules,
in response to a purchase, providing information to the managing server relating to a purchase in progress, by means of a first communication terminal (120) operated by a provider,
examining by the server whether information provided is in accordance with the purchasing rules, as a result of which a notification is sent to the first communication terminal so as to validate the purchase.

12. Computer program for causing a computer apparatus to manage and audit purchases in progress which are made by a number of individuals belonging to a liable organization, such as employees making purchases in parallel on behalf of a company, comprising a computer readable code, which when run causes the computerized apparatus to perform the method steps comprising,
connecting a managing server (100) to an global interconnected net-work (105), such as the Internet, the server including a storage means (140) and issuing means (150);
providing information to the storage means of the server about purchasing rules for individuals purchasing on behalf of their organization which in-formation is provided by a client terminal (130) connected to the network;
generating a unique number by the issuing means, the number being is-sued and distributed to a purchasing individual in dependence on the purchasing rules;
in response to a purchase, providing information to the managing server relating to a purchase in progress, by means of a first communication terminal (120) operated by a provider; and
examining by the server whether information provided is in accordance with the purchasing rules, as a result of which a notification is sent to the first communication terminal so as to validate the purchase.

13. (canceled)

14. (canceled)

15. A computer program product in a computer readable medium having computer program code recorded thereon, wherein the program code includes sets of instructions to manage and audit purchases in progress which are made by a number of individuals belonging to a liable organization, such as employees making purchases in parallel on behalf of a company in a computer system, said instructions comprising steps for:
connecting a managing server (100) to an global interconnected net-work (105), such as the Internet, the server including a storage means (140) and issuing means (150);
providing information to the storage means of the server about purchasing rules for individuals purchasing on behalf of their organization which in-formation is provided by a client terminal (130) connected to the network;
generating a unique number by the issuing means, the number being is-sued and distributed to a purchasing individual in dependence on the purchasing rules;
in response to a purchase, providing information to the managing server relating to a purchase in progress, by means of a first communication terminal (120) operated by a provider; and
examining by the server whether information provided is in accordance with the purchasing rules, as a result of which a notification is sent to the first communication terminal so as to validate the purchase.

16. A computer program product according to claim 15, wherein the computer readable medium is a propagated signal and the propagated signal is a carrier wave.
